(19) United States
(12) Patent Application Publication
(10) Pub. No.: US 2021/0160238 A1
(43) Pub. Date: May 27, 2021

(54) METHOD, AN APPARATUS AND A STORAGE MEDIUM FOR NETWORK CONNECTION

(71) Applicant: LIANSHANG (XINCHANG) NETWORK TECHNOLOGY CO., LTD., SHAOXING (CN)

(72) Inventor: Peixi WU, SHAOXING (CN)

(21) Appl. No.: 17/167,097

(22) Filed: Feb. 4, 2021

Related U.S. Application Data
(63) Continuation of application No. PCT/CN2019/098538, filed on Jul. 31, 2019.

(30) Foreign Application Priority Data
Aug. 6, 2018 (CN) 201810886393.9

(51) Int. Cl. H04L 29/06

(52) U.S. Cl. CPC H04L 63/0876

(57) ABSTRACT

The present disclosure discloses a method, an apparatus and a storage medium for network connection, which relates to the technical field of network technology. The method comprises: monitoring for a connection request for a hotspot outside of a networking application, wherein the hotspot is a WEB authentication-based hotspot; launching a browser and determining a connection mode, wherein the browser is a networking application browser or a general browser; connecting to the corresponding hotspot in the networking application or outside of the networking application according to the determined connection mode.

### CROSS REFERENCE TO THE RELATED APPLICATION

This application is the continuation application of International Application No. PCT/CN2019/098538, filed on Jul. 31, 2019, which is based upon and claims priority to Chinese Patent Application No. 201810886393.9, filed on Aug. 6, 2018, the entire contents of which are incorporated herein by reference.

### FIELD

The present disclosure relates to network technology, and more specifically relates to a method, an apparatus and a storage medium for network connection.

### BACKGROUND

With the continuous development of modernization construction, the Internet has become popular widely, which brings great convenience to people's lives and office businesses. To enable people to connect to the Internet quickly and effectively, many networking applications emerge as the times require, such as Master Key and WIFI Manager.

Currently, to provide customers with better consumption experience, many merchants will not only provide network hotspots to customers for network connection, but also choose and provide hotspots which can be quickly connected and developed by network operators in cooperation with networking application developers to customers. Consequently, on one hand, this provides customers with more options of modes for network connection. On the other hand, this provides users with more convenient and quicker networking experience. However, when a customer selects to use a networking function of a mobile device for network connection, that is, connecting to the network outside of the networking application, the network connection would be implemented by way of WEB authentication. The next time the customer wants to connect to the network, the WEB authentication would be required again, which degrades customer experience to a certain extent. Besides, connecting to the network outside of the networking application would not bring additional clicks and openings to the networking application, that is, utilization rate of the networking application would not be increased and thus a win-win cooperation would not be achieved.

### SUMMARY

The objective of the present disclosure is achieved through the following technical solutions.

In a first aspect, it is provided in the present disclosure a method for network connection, which comprises:

monitoring for a connection request for a hotspot outside of a networking application, wherein the hotspot is a WEB authentication-based hotspot;

launching a browser and determining a connection mode, wherein the browser is a networking application browser or a general browser; and

connecting to the corresponding hotspot in the networking application or outside of the networking application according to the determined connection mode.

In one embodiment, launching the browser specifically comprises:

displaying an option of the networking application browser and an option of the general browser for a user to select, and launching the browser corresponding to the option selected by the user; or launching a default browser.

In one embodiment, determining the connection mode comprises:

when the networking application browser is launched, determining the connection mode as connecting to the hotspot in the networking application; and

when the general browser is launched, displaying options of connection modes including an option of connecting to the hotspot in the networking application and an option of connecting to the hotspot outside of the networking application for a user to select, and determining the mode corresponding to the option selected by the user as the connection mode.

In one embodiment, before connecting to the corresponding hotspot in the networking application according to the determined connection mode when the determined connection mode is connecting to the hotspot in the networking application, the method further comprises:

determining whether the networking application has been installed on a corresponding device, and downloading the networking application in a preset manner if it is determined that the networking application has not been installed on the corresponding device.

In one embodiment, connecting to the corresponding hotspot in the networking application according to the determined connection mode comprises:

opening the networking application, and determining whether a corresponding user has been authenticated and logged in; if so, connecting to the corresponding hotspot through the networking application; otherwise, guiding the user to be authenticated and to log in, and connecting to the corresponding hotspot through the networking application after successful authentication and login.

In one embodiment, determining whether the corresponding user has been authenticated and logged in specifically comprises: obtaining a MAC address of the corresponding device, and determining whether user data contains the MAC address and corresponding login Information; if so, determining that the authentication and login have been completed; otherwise, determining that the authentication and login have not been completed.

In one embodiment, guiding the user to be authenticated and to log in after successful authentication and login further comprises: storing login information submitted by the user and the obtained MAC address into the user data correspondingly.

In one embodiment, connecting to the corresponding hotspot outside of the networking application according to the determined connection mode comprises: verifying an identity of the corresponding user through a verification code, and connecting to the corresponding hotspot outside of the networking application if the verification is successful.

In one embodiment, verifying the identity of the corresponding user through the verification code comprises: transmitting a verification code to a mobile phone number submitted by the user, and receiving a verification code submitted by the user, and determining whether the received verification code matches the transmitted verification code; if so, determining that the verification is passed; otherwise, determining that the verification is not passed.

In a second aspect, it is provided in the present disclosure an apparatus for network connection, which comprises:

one or more processors, storage means for storing one or more programs;

wherein the one or more programs, when executed by the one or more processors, implement the method as recited in the first aspect of the present disclosure.

In a third aspect, it is provided in the present disclosure a computer readable storage medium storing computer programs thereon. The computer programs, when executed by a processor, implement the method as recited in the first aspect of the present disclosure.

The advantages of the present disclosure lie in:

in the present disclosure, when the connection request for the hotspot outside of the networking application is monitored, multiple options including an option of the networking application browser are displayed for a user to select to give an opportunity to the user to select to connect to the Internet in the networking application or the networking application browser is launched, and it is determined whether the user has been authenticated and logged in by the networking application, so that the user does not need to be authenticated again to log in if it is determined that the user has been authenticated and logged in, which improves user experience. Meanwhile, click rate of the networking application can be greatly increased by launching the networking application browser or providing an option for the user to select to connect to the network in the networking application, which achieves a win-win cooperation.

### DESCRIPTIONS OF THE DRAWINGS

Various other advantages and benefits will become apparent to those of ordinary skill in the art in the art by reading the detailed description of the embodiment below. The drawings are only for the purpose of illustrating the embodiments and are not considered as a limitation of the disclosure. Throughout the drawings, the same reference numerals are used to refer to the same parts. In the drawings:

FIG. 1 is a flowchart of a method for network connection according to an embodiment of the present disclosure; and

FIG. 2 is a block diagram of an apparatus for network connection according to an embodiment of the present disclosure.

### DETAILED EMBODIMENTS

Exemplary embodiments of the present disclosure will be described in more detail below with reference to the accompanying drawings. While the exemplary embodiments of the present disclosure are shown in the drawings, it is understood that the disclosure may be embodied in various forms and not limited by the embodiments set forth herein. Rather, these embodiments are provided so that this disclosure will be more fully understood, and the scope of the disclosure can be fully conveyed to those skilled in the art.

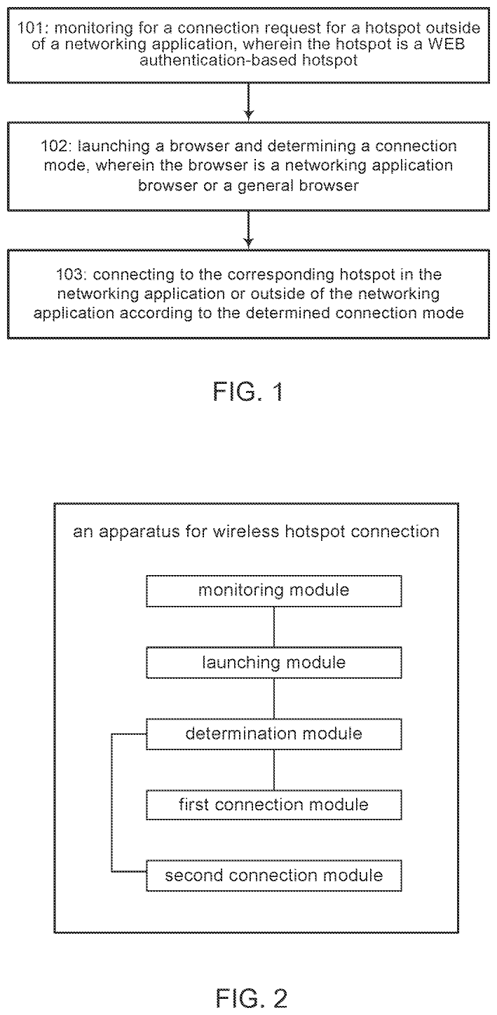

According to an embodiment of the present disclosure, a method for network connection is proposed. As shown in FIG. 1, the method comprises:

Step 101, a connection request for a hotspot outside of a networking application is monitored, wherein the hotspot is a Web authentication-based hotspot.

Specifically, a monitoring thread is registered to monitor for a connection request for a hotspot from a user in real time. When a connection request for a WEB authentication-based hotspot outside of the networking application is monitored, step 102 is performed.

For example, the networking application is WiFi Master Key.

It should be noted that the hotspot in the present disclosure is a hotspot which can be quickly and effectively connected and is developed by the network operator, wherein the network operator cooperates with the networking application developer in business.

It should also be noted that “outside of the networking application” used herein means that the networking application is not being used. In an example, “monitoring for a connection request for a hotspot outside of the networking application” means monitoring for a connection request for a hotspot, wherein the connection request is initiated for example via a system networking interface, rather than using the networking application. In another example, connecting to the corresponding hotspot outside of the networking application means that network connection to the hotspot is performed without using the networking application, but rather for example using a general browser with a verification code.

Step 102, a browser is launched and a connection mode is determined, wherein the browser is a networking application browser or a general browser.

According to the embodiment of the present disclosure, launching the browser in step 102 further comprises:

displaying an option of the networking application browser and an option of the general browser for a user to select, and launching the browser corresponding to the option selected by the user; or launching a default browser.

The general browser comprises browsers which are widely used currently, such as Baidu browser, UC browser, IE browser, etc. In one embodiment, the default browser is a networking application browser.

In the present disclosure, multiple options including an option of the networking application browser are displayed for a user to select so as to give an opportunity to the user to select to connect to the Internet in the networking application or the default networking application browser is launched, and then it is determined whether the user has been authenticated and logged in by the networking application browser, so that the user does not need to be authenticated again to log in if it is determined that the user has been authenticated and logged in, which improves user experience. Meanwhile, click rate of the networking application can be greatly increased by launching the networking application browser or providing an option for the user to select to connect to the network in the networking application, which achieves a win-win cooperation.

According to the embodiment of the present disclosure, determining the connection mode in step 102 comprises:

determining a type of the browser which is launched. When the networking application browser is launched, the connection mode is determined as connecting to the hotspot in the networking application. When the general browser is launched, options of connection modes including an option of connecting to the hotspot in the networking application and an option of connecting to the hotspot outside of the networking application are displayed for a user to select and the mode corresponding to the option selected by the user is determined as the connection mode.

In one embodiment, the connection mode of connecting to the hotspot outside of the networking application is a connection mode with a verification code.

For example, three options including the networking application browser, Baidu browser, and UC browser are displayed to a user. If the received option selected by the user is UC browser, then it will jump to the UC browser and display two options of connection modes, including an option of connecting to the hotspot in the networking application and an option of connecting to the hotspot with the verification code. If the received option selected by the user is to connect to the hotspot in the networking application, the connection mode is determined as connecting to the hotspot in the networking application.

Further, in the present disclosure, before connecting to the corresponding hotspot in the networking application according to the determined connection mode when the connection mode is determined as connecting to the hotspot in the networking application, it further comprises:

determining whether the networking application has been installed on a corresponding device, and downloading the networking application in a preset manner if it is determined that the networking application has not been installed on the corresponding device.

Determining whether the networking application has been installed on a corresponding device further comprises: invoking a preset function interface to scan application identifications of the installed applications on the device, and determining whether the scanned application identifications contain an identification of the networking application. If so, it is determined that the networking application has been installed on the device. Otherwise, it is determined that the networking application has not installed on the device.

Further, downloading the networking application in a preset manner further comprises downloading the networking application without user data.

More specifically, the step of downloading the networking application without user data is performed by way of a temporary release or a white list mechanism.

Performing the step of downloading the networking application without user data by way of a temporary release specifically comprises: obtaining a MAC address of the corresponding device, transmitting the MAC address to a server of a network operator, and temporarily allocating a preset time period of network connection to the corresponding device so that the corresponding device is able to download the networking application without user data.

Performing the step of downloading the networking application without user data by way of a white list mechanism specifically comprises: obtaining a MAC address of the corresponding device, transmitting the MAC address to a server of a network operator and adding the MAC address to a white list of a router, and giving network access permission to the corresponding device so that the corresponding device is able to download the networking application without user data.

Step 103, the corresponding hotspot is connected in the networking application or outside of the networking application according to the determined connection mode.

According to the embodiment of the present disclosure, connecting to the corresponding hotspot in the networking application according to the determined connection mode in step 103 comprises:

opening the networking application, and determining whether a corresponding user has been authenticated and logged in; if so, connecting to the corresponding hotspot through the networking application; otherwise, guiding the user to be authenticated and to log in, and connecting to the corresponding hotspot through the networking application after successful authentication and login.

Determining whether the corresponding user has been authenticated and logged in specifically comprises: obtaining a MAC address of the corresponding device, and determining whether user data contains the obtained MAC address and corresponding login Information; if so, determining that the authentication and login have been completed; otherwise, determining that the authentication and login have not been completed.

Accordingly, guiding the user to be authenticated and to log in after successful authentication and login further comprises: storing login information submitted by the user and the obtained MAC address into the user data correspondingly.

The login information comprises a user account (e.g., a mobile phone number) and a login password. In the present disclosure, to ensure a safe and orderly Internet environment, each user needs to be authenticated and to log in through his/her own user account and login password when he/she is going to connect to the Internet.

Further, in the present disclosure, if it is determined that the user has been authenticated and logged in or if the user is guided to be authenticated and to log in successfully, it further comprises: generating a Token according to the user's login information, and transmitting the Token to a server of a network operator to give network access permission to the corresponding user.

According to the embodiment of the present disclosure, connecting to the corresponding hotspot outside of the networking application according to the determined connection mode in step 103 comprises: verifying an identity of the corresponding user through a verification code, and connecting to the corresponding hotspot outside of the networking application if the verification is successful.

Verifying the identity of the corresponding user through the verification code comprises: transmitting a verification code to a mobile phone number submitted by the user, and receiving a verification code submitted by the user, and determining whether the received verification code matches the transmitted verification code; if so, determining that the verification is passed; otherwise, determining that the verification is not passed.

In one embodiment, if the determined connection mode is to connect to the hotspot outside of the networking application, and the networking application has not been installed on the device, after connecting to the corresponding hotspot outside of the networking application according to the determined connection mode in step 103, it further comprises: downloading the networking application without data.

Furthermore, in the present disclosure, connecting to the hotspot in the networking application also comprises: ranking a cooperative hotspot out of the scanned hotspots higher and displaying the hotspot with a label. Connecting to the hotspot outside of the networking application also comprises: prompting the user to connect to the scanned cooperative hotspot. The cooperative hotspot used herein refers to a hotspot developed by a network operator that cooperates with the networking application developer in business.

According to an embodiment of the present disclosure, an apparatus for wireless hotspot connection is also proposed. As shown in FIG. 2, the apparatus comprises:

a monitoring module used to monitor for a connection request for a hotspot outside of a networking application, wherein the hotspot is a Web authentication-based hotspot;

a launching module used to launch the browser which is a networking application browser or a general browser;

a determination module used to determine a connection mode according to the browser launched by the launch module;

a first connection module used to connect to the corresponding hotspot in the networking application according to the connection mode determined by the determination module;

a second connection module used to connect to the corresponding hotspot outside of the networking application according to the connection mode determined by the determination module.

According to the embodiment of the present disclosure, the launching module is specifically used to: display an option of the networking application browser and an option of the general browser for a user to select, and launch the browser corresponding to the option selected by the user; or launch a default browser.

According to the embodiment of the present disclosure, the determination module is specifically used to:

determine the connection mode as connecting to the hotspot in the networking application when the networking application browser is launched;

display options of connection modes including an option of connecting to the hotspot in the networking application and an option of connecting to the hotspot outside of the networking application for a user to select when the general browser is launched, and determine the mode corresponding to the option selected by the user as the connection mode.

According to the embodiment of the present disclosure, the apparatus further comprises: an evaluation module and a downloading module.

The evaluation module is used to evaluate whether the networking application has been installed on the corresponding device when the connection mode determined by the determination module is connecting to the hotspot in the networking application.

The downloading module is used to download the networking application in a preset manner when the evaluation module determines that the networking application has not been installed on the corresponding device.

The first connection module is specifically used to connect to the corresponding hotspot in the networking application according to the connection mode determined by the determination module when the evaluation module determines that the networking application has been installed on the corresponding device.

According to the embodiment of the present disclosure, the first connection module comprises: an opening sub-module, an evaluation sub-module, a connection sub-module and a guiding sub-module, wherein:

the opening sub-module is used to open the networking application;

the evaluation sub-module is used to evaluate whether the corresponding user has been authenticated and logged in;

the connection sub-module is used to connect to the corresponding hotspot through the networking application when the evaluation sub-module determines that the corresponding user has been authenticated and logged in;

the guiding sub-module is used to guide the user to be authenticated and to log in when the evaluation sub-module determines that the corresponding user has not been authenticated and logged in;

the connection sub-module is also used to connect to the corresponding hotspot in the networking application after the guiding sub-module guiding the user to be authenticated and to log in successfully.

According to the embodiment of the present disclosure, the evaluation sub-module is specifically used to: obtain a MAC address of the corresponding device, determine whether the user data contains the obtained MAC address and corresponding login information; if so, it is determined that the authentication and login have been completed; otherwise, it is determined that the authentication and login have not been completed.

According to the embodiment of the present disclosure, the apparatus further comprises: a storing module.

The storing module is used to store login information submitted by the user and the MAC address obtained by the evaluation sub-module into the user data correspondingly after the guiding module guiding the user to be authenticated and logged in successfully.

According to the embodiment of the present disclosure, the second connection module comprises: a verification sub-module and a connection sub-module.

The verification sub-module is used to verify an identity of the corresponding user through a verification code.

The connection sub-module is used to connect to the corresponding hotspot outside of the networking application if the verification sub-module performs the verification successfully.

According to the embodiment of the present disclosure, the verification sub-module is specifically used to: transmit a verification code to a mobile phone number submitted by the user, and receive a verification code submitted by the user, and determine whether the received verification code matches the transmitted verification code; if so, it is determined that the verification is passed; otherwise, it is determined that the verification is not passed.

According to an embodiment of the present disclosure, an apparatus for wireless hotspot connection is also proposed. The apparatus comprises:

one or more processors, storage means for storing one or more programs;

wherein the one or more programs, when executed by the one or more processors, implement steps of the method for wireless hotspot connection as recited above.

According to an embodiment of the present disclosure, a computer readable storage medium storing computer programs thereon is also proposed. The computer programs, when executed by a processor, implement steps of the method for wireless hotspot connection as recited above.

In the present disclosure, when the connection request for the hotspot outside of the networking application is monitored, multiple options including an option of the networking application browser are displayed for a user to select so as to give an opportunity to the user to select to connect to the Internet in the networking application or the networking application browser is launched, and it is determined whether the user has been authenticated and logged in by the networking application, so that the user does not need to be authenticated again to log in if it is determined that the user has been authenticated and logged in, which improves user experience. Meanwhile, click rate of the networking application can be greatly increased by launching the networking application browser or providing an option of connecting to a network in the networking application for the user to select, which achieves a win-win cooperation.

The above is only some embodiments of the present disclosure. The protection scope of the present disclosure is not limited thereto, and changes or alternatives within the technical scope disclosed by the present disclosure easily appreciated by any person skilled in the art should be encompassed by the protection scope of the present disclosure. Therefore, the protection scope of the present disclosure should be determined by the scope of the claims.

What is claimed is:

1. A method for network connection, comprising:
monitoring for a connection request for a hotspot outside of a networking application, wherein the hotspot is a WEB authentication-based hotspot;
launching a browser and determining a connection mode, wherein the browser is a networking application browser or a general browser; and
connecting to the corresponding hotspot in the networking application or outside of the networking application according to the determined connection mode.

2. The method of claim 1, wherein launching the browser further comprising:
displaying an option of the networking application browser and an option of the general browser for a user to select, and launching the browser corresponding to the option selected by the user; or
launching a default browser.

3. The method of claim 1, wherein determining the connection mode comprising:
when the networking application browser is launched, determining the connection mode as connecting to the hotspot in the networking application; and
when the general browser is launched, displaying options of connection modes including an option of connecting to the hotspot in the networking application and an option of connecting to the hotspot outside of the networking application for a user to select, and determining the mode corresponding to the option selected by the user as the connection mode.

4. The method of claim 3, before connecting to the corresponding hotspot in the networking application according to the determined connection mode when the determined connection mode is connecting to the hotspot in the networking application, the method further comprising:
determining whether the networking application has been installed on a corresponding device, and downloading the networking application in a preset manner if it is determined that the networking application has not been installed on the corresponding device.

5. The method of claim 1, wherein connecting to the corresponding hotspot in the networking application according to the determined connection mode comprising:
opening the networking application, and determining whether a corresponding user has been authenticated and logged in; if so, connecting to the corresponding hotspot through the networking application; otherwise, guiding the user to be authenticated and to log in, and connecting to the corresponding hotspot through the networking application after successful authentication and login.

6. The method of claim 5, wherein determining whether the corresponding user has been authenticated and logged in further comprising: obtaining a MAC address of the corresponding device, and determining whether user data contains the MAC address and corresponding login Information; if so, determining that the authentication and login have been completed; otherwise, determining that the authentication and login have not been completed.

7. The method of claim 6, wherein guiding the user to be authenticated and to log in after successful authentication and login further comprising: storing login information submitted by the user and the obtained MAC address into the user data correspondingly.

8. The method of claim 1, wherein connecting to the corresponding hotspot outside of the networking application according to the determined connection mode comprising: verifying an identity of the corresponding user through a verification code, and connecting to the corresponding hotspot outside of the networking application if the verification is successful.

9. The method of claim 8, wherein verifying the identity of the corresponding user through the verification code comprises: transmitting a verification code to a mobile phone number submitted by the user, and receiving a verification code submitted by the user, and determining whether the received verification code matches the transmitted verification code; if so, determining that the verification is passed; otherwise, determining that the verification is not passed.

10. An apparatus for network connection, comprising:
one or more processors, storage means for storing one or more programs;
wherein the one or more programs, when executed by the one or more processors, cause the one or more processors to:
monitor for a connection request for a hotspot outside of a networking application, wherein the hotspot is a WEB authentication-based hotspot;
launch a browser and determining a connection mode, wherein the browser is a networking application browser or a general browser; and
connect to the corresponding hotspot in the networking application or outside of the networking application according to the determined connection mode.

11. A computer readable storage medium storing computer programs thereon, wherein the computer programs, when executed by a processor, cause the processor to:
monitor for a connection request for a hotspot outside of a networking application, wherein the hotspot is a WEB authentication-based hotspot;
launch a browser and determining a connection mode, wherein the browser is a networking application browser or a general browser; and
connect to the corresponding hotspot in the networking application or outside of the networking application according to the determined connection mode.
